(19) United States
(12) Patent Application Publication
(10) Pub. No.: US 2017/0005541 A1
(43) Pub. Date: Jan. 5, 2017

(54) STARTER FOR A THERMAL ENGINE OF A MOTOR VEHICLE PROVIDED WITH A ROTARY ELECTRICAL MACHINE WITH AN IMPROVED PROJECTING POLE INDUCTOR AND CORRESPONDING POLE SHOE

(71) Applicant: VALEO EQUIPMENTS ELECTRIQUES MOTEUR, Creteil Cedex (FR)

(72) Inventors: Pierre MOLLON, Estrablin (FR); Eric FOREL, Francheville (FR); Wilfried PAYS, Sermerieu (FR); Raphaël ANDREUX, Lyon (FR)

(21) Appl. No.: 15/104,783

(22) PCT Filed: Dec. 18, 2014
(86) PCT No.: PCT/FR2014/053426

§ 371 Date: Jun. 15, 2016

(30) Foreign Application Priority Data
Dec. 20, 2013 (FR) 1363299

(51) Int. Cl. H02K 7/00; H02K 13/00; H02K 1/26; H02K 1/14; H02K 3/18

(52) U.S. Cl. CPC H02K 7/006; H02K 1/146; H02K 3/18; H02K 1/26; H02K 13/00; H02K 2201/03

(57) ABSTRACT

A motor vehicle heat engine starter comprising a rotary electric machine (5) that has a rotor (9) and a stator (8) and comprises a plurality of magnetic poles (65) arranged on an internal circumference of a yoke (66). Each magnetic pole (65) is made up of a salient pole shoe (69) surrounded by a winding (70). The starter is characterized in that an air gap (76), separating the rotor (9) from the magnetic poles (65) of the stator (8), varies according to the circumference thereof. The invention also relates to a corresponding pole shoe (69).

The invention relates to a starter for a thermal engine of a motor vehicle provided with a rotary electrical machine with an improved projecting pole inductor, as well as to the corresponding pole shoe. The invention has a particularly advantageous, but not exclusive application with starters of so-called stop and start systems, which make it possible to stop and restart the thermal engine of the vehicle in particular according to the traffic conditions.

In order to start a thermal engine, in particular of a motor vehicle, it is known to use a starter provided with a launcher which can transmit rotational energy of the starter to a crankshaft of the thermal engine by means of a starter ring. This launcher is fitted on a drive shaft. According to one embodiment, a speed reducer is interposed between this drive shaft and the shaft of an electric motor.

This electric motor comprises firstly a rotor, which is also known as an armature, and secondly a stator, which is also known as an inductor, fitted coaxially around the rotor. The rotor comprises a body in the form of a set of plates provided with notches which are each delimited by two successive teeth. The rotor additionally comprises wires which are wound in the notches in order to form the rotor winding.

In the location of each magnetic pole, the stator has a radially projecting pole shoe around which an inductor wire is wound. These pole shoes are generally in the form of a parallelepiped with curvature which is adapted to the radius of the armature, in order to leave a small constant air gap between the armature and the magnetic poles, such as to make the electromagnetic conversion as efficient as possible.

In addition, the rotor is provided with a collector comprising a plurality of contact parts which are connected electrically to the conductors of the rotor winding. A set of brushes is provided for the electrical supply of the winding, certain brushes being connected to the earth of the starter, and others being connected to an electric terminal of a contactor. The brushes rub on the plates of the collector when the rotor is rotating in order to allow the rotor to be supplied with power by switching of the electric current.

One of the main sources of noise of the electric motor is the “collector brush frequency” and its harmonics. This frequency, which is generally close to hissing, is the multiple of the frequency of rotation of the armature and the number of plates of the collector (and therefore the number of teeth of the rotor). This source has two origins, i.e. a mechanical one caused by the rubbing of the brushes on the collector of the armature, and the other one electromagnetic.

In fact, the rotor is subjected to electromagnetic forces comprising tangential components, (which give rise to the rotation of the armature), but also radial components corresponding to a so-called “rotary” force, which can create deformations of the parts on which they are applied, in particularly the poles and the head of the motor of the starter. These deformations then give rise to the noise, which can be all the greater, the stronger the torque supplied by the starter.

The objective of the invention is to eliminate this disadvantage efficiently by proposing a starter for a thermal engine of a motor vehicle comprising a rotary electrical machine provided with a rotor and a stator, comprising a plurality of magnetic poles arranged on an inner circumference of a head, wherein each magnetic pole projects relative to the head surrounded by a winding, and an axial air gap, between a circumferential surface of at least two magnetic poles opposite a circumferential surface of the said rotor and a circle with a radius of the exterior of the rotor, varies by at least 1 mm.

The variation of the air gap thus makes it possible to minimise the rotary force, and therefore the resulting noise, during the actuation of the starter, without detracting significantly from the torque produced by the electric motor.

“Head” means the part of the stator which makes it possible to pass a flux between two magnetic poles.

According to one embodiment, each magnetic pole is constituted by a pole shoe fitted against the head of the stator.

According to another embodiment, the stator comprises a stack of plates forming the head and the different magnetic poles.

According to one embodiment, the magnetic pole comprises a groove which forms the variation of the air gap.

According to one embodiment, the air gap varies by at least 1 mm on a circumferential end of its circumferential surface.

According to another embodiment, the surface on which the air gap varies according to the circumference also varies axially.

According to one embodiment, with each pole shoe comprising a flare, the said air gap is larger between an area of the said flare and the said rotor than between a central portion of the magnetic pole and the said rotor.

According to one embodiment, an increase in the said air gap is obtained by means of a discontinuity of an inner face of at least one magnetic pole situated opposite the said rotor.

According to one embodiment, the discontinuity is defined by at least one flat surface provided in the inner face of a magnetic pole.

According to one embodiment, the said flat surface is provided in the said flare.

According to one embodiment, there is definition of a first plane parallel to an axis of the said stator passing via an outer end of the said flat surface, a second plane parallel to the said axis of the said stator passing via an intersection between a circle corresponding to an arc of a circle defining part of an inner face of a magnetic pole, and a third plane perpendicular to the first plane passing via the said outer end of the said flat surface, the distance between the first and the second planes corresponding to a chamfer height provided in the said flare which is between 1.5 mm and 2.8 mm.

This makes it possible to minimise the noise generated by the electric motor of the starter, whilst maintaining efficient motor torque for the two cases of operation of the starter (conventional starting of the vehicle when its thermal engine is cold, and restarting of the thermal engine which is already warm in stop and start mode).

According to one embodiment, the said flat surface is situated substantially on the first plane.

According to one embodiment, the said pole shoes are added on to the said head of the said stator. This therefore facilitates the assembly of the stator.

According to one embodiment, the starter is configured to operate with a current of approximately 600 A for starting from cold of the thermal engine, or a current of approximately 250 A for starting of the thermal engine in its stop and start mode.

According to one embodiment, the said rotor comprises 19 notches which are designed to receive conductors for the formation of a rotor winding.

The invention also relates to a pole shoe belonging to an inductor of an electric starter motor of a motor vehicle, characterised in that it comprises an inner face which is designed to be situated opposite a rotor of the said electric motor, with a discontinuity which breaks the regularity of an arc of a circle which defines part of the said inner face.

The invention will be better understood by reading the following description and examining the figures which accompany it. These figures are provided purely by way of illustration of the invention which is in no way limiting.

FIG. 1 shows a view in longitudinal cross-section of a starter of a thermal engine according to the present invention;

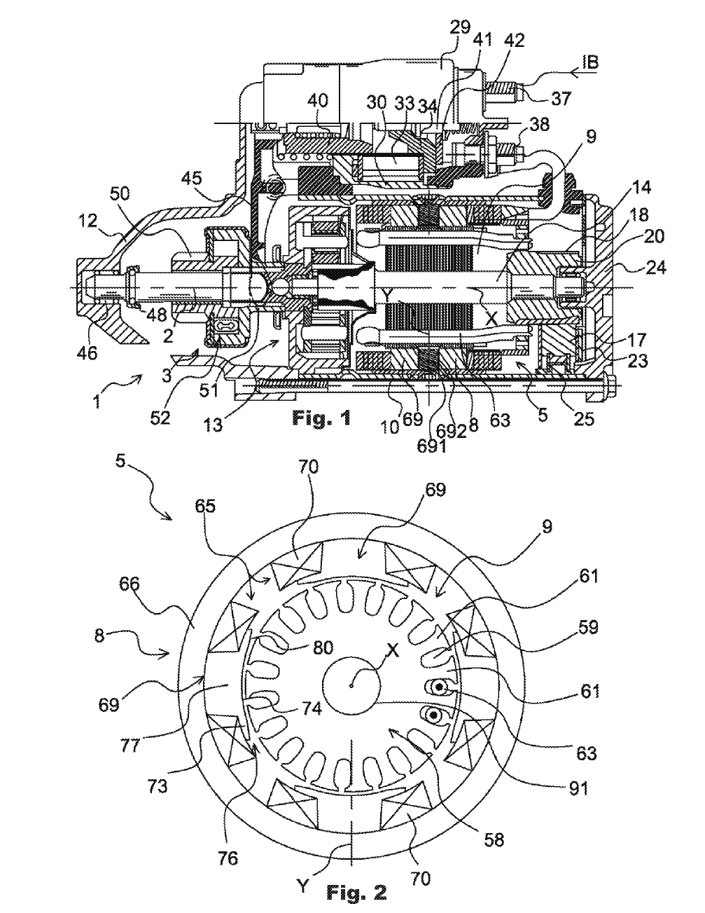

FIG. 2 represents according to a first embodiment a schematic view in transverse cross-section of the electric motor used with the starter according to the present invention;

FIG. 3 shows according to a first embodiment a detailed side view of a pole shoe used with the electric motor of the starter according to the present invention;

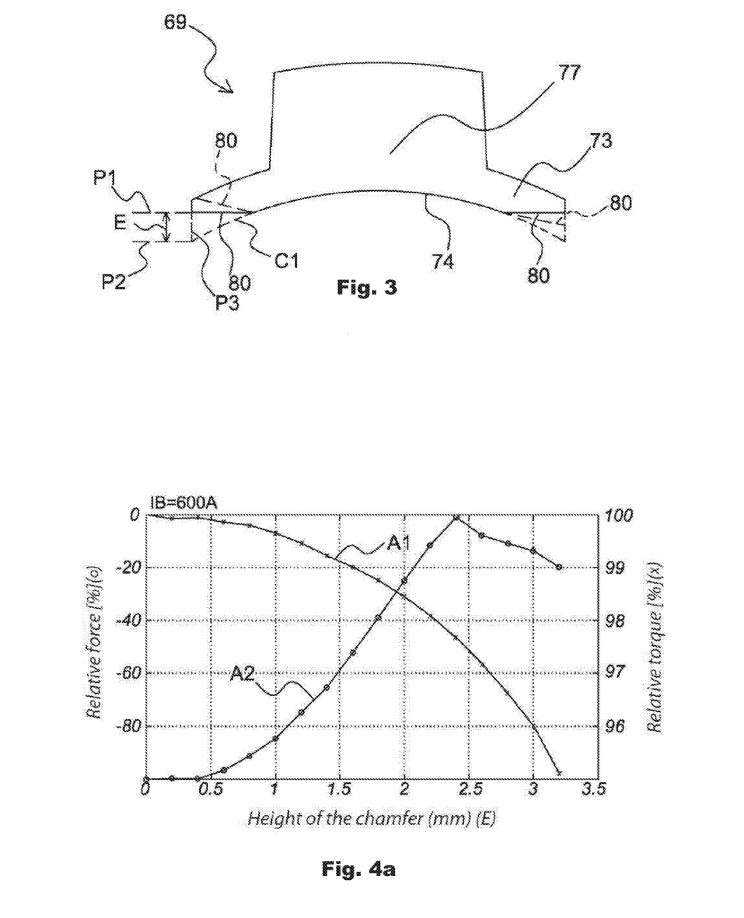

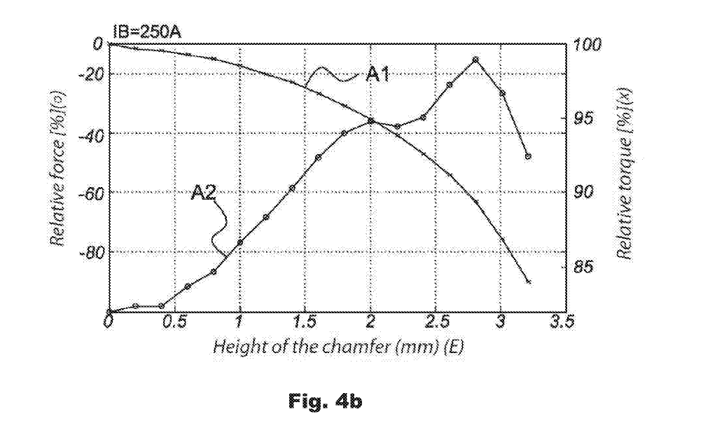

FIGS. 4a and 4b show respectively graphic representations of the relative developments of the motor torque and the amplitude of the rotary force from which the noise is derived, according to the height of a chamfer provided in the pole shoe for a battery current of approximately 600 A and 250 A;

FIG. 5 represents according to another embodiment a detailed side view of a pole shoe used with the electric motor of the starter according to the present invention.

Elements which are identical, similar or analogous retain the same reference from one figure to another. In the description, “magnetic pole” and “magnetic mass” mean respectively a magnetic pole and magnetic mass of the stator.

With reference to FIG. 1, the starter 1 according to the invention comprises a drive shaft 2, a launcher 3 which is fitted on the shaft 2, and an electric motor 5 which is described in greater detail hereinafter, consisting of an inductor stator 8 and an induced rotor 9 fitted coaxially according to an axis X. The stator 8 surrounds the rotor 9 which is integral with a shaft 14. The motor 5 comprises a casing 10 fitted on a metal support 12 of the starter 1 which is designed to be secured on a fixed part of the motor vehicle.

A speed reducer 13 with gears of the planetary gear train type is preferably interposed between a rear end of the drive shaft 2 and the shaft 14 of the electric motor 5.

Brushes 17 rub on conductive plates 18 of a collector 20 in order to supply the rotor winding. The brushes 17 belong to a brush-holder 23 which is equipped with cages for guiding and receipt of the brushes 17. These brushes 17 are thrust in the direction of the conductive plates 18 by resilient means 25 of the spring type. The brush-holder 23 is integral with a rear flange 24 which has in its central part a receptacle for fitting of a needle bearing. The bearing of the rear flange 24 is used for fitting with rotation of an end of the shaft 14 of the electric motor 5.

The starter 1 also comprises an electromagnetic contactor 29 which extends parallel to the electric motor 5, and is implanted radially above the latter. The contactor 29 has a metal dish 30 which is supported by the support 12, and is equipped with an excitation coil 33 provided with at least one winding. A shoulder of the dish 30 makes it possible to ensure the axial wedging of a fixed core 34.

Terminals 37, 38 are formed such as each to establish a fixed contact in the interior of the dish 30. One of the terminals 37 is designed to be connected to the positive terminal of the vehicle battery, and the other terminal 38 is connected to the input of the inductor winding of the stator 8 and to the brushes 17 with positive polarities. In a known manner, during the excitation of the coil 33, a mobile core 40 is attracted by means of magnetic attraction in the direction of the fixed core 34, in order firstly to act after elimination of play on a rod 41 which supports a mobile contact 42, to give rise to the closure of the contacts of the contactor 29, and supply the electric motor 5 of the starter 1, and secondly to actuate a control lever 45 of the launcher 3.

The drive shaft 2 is fitted such as to rotate in a front bearing 46 of the support 12. This bearing 46 is constituted for example by a needle bearing, or as a variant by a plain bearing. This shaft 2 supports at the front a stop 48 which is adjacent to the bearing 46, in order to limit the displacement of the launcher 3.

The launcher 3 is fitted such as to slide on the drive shaft 2, and comprises a drive pinion 50, a driver 51 which is configured to be actuated by the pivoting control lever 45, and a free wheel device 52, for example of the roller type, installed between the driver 51 and the pinion 50.

The upper end of the lever 45 is fitted in a known manner articulated on a rod which is connected resiliently to the mobile core 40 via a spring, known as the tooth-against-tooth spring, accommodated in the mobile core 40.

In a known manner, the driver 51 is provided in its interior with helical ribbing which is engaged in a complementary manner with outer helical toothing supported by the drive shaft 2. The launcher 3 is thus driven with helical movement when it is displaced by the lever 45 in the direction of the stop 48, in order to be engaged by means of its pinion 50 with the starter ring of a thermal engine 5 (not represented).

It is apparent that the free wheel device 52 can be replaced by a conical clutch device, or a clutch which is provided with a plurality of friction discs, as described in document FR2978500. Similarly, it is apparent that as a variant, the launcher 3 is implanted on the exterior of the support 12.

In the embodiment in FIG. 2, the rotor 9 comprises a body 58 in the form of a set of plates provided with notches 59, each of which is delimited by two successive teeth 61. The body 58 comprises a through central opening 91, which permits mounting on the shaft 14 for example by force fitting. The rotor 9 additionally comprises wires which are wound in the notches 59 in order to form the rotor winding 63. In connection with the conductive plates 18 of the collector 20, this winding 63 is integral with the shaft of the electric motor 5. In this case, the rotor 9 comprises K=19 teeth, i.e. 19 conductive plates. The rotor 9 has for example an outer diameter of approximately 49.7 mm.

The stator 8 comprises a plurality of magnetic poles 65 arranged on an inner circumference of a head 66. Each pole 65 is constituted by a pole shoe 69 which projects in a globally parallelepiped form surrounded by a winding 70. Each winding 70 is retained by a flare 73 of the pole shoe 69. The axis Y of each winding 70 is radial relative to the axis X of the stator 8. In this case, the inductor winding comprises two pairs of North and South windings 70, which are each wound around a pole shoe 69 which is integral with the head 66. Each winding 70 consists of an electrical conductor through which a direct current passes.

As can be seen in FIG. 1, each added-on pole shoe 69 is secured against the inner circumference of the head 66 by means of a securing screw 691 inserted in a through opening 692 provided in the pole shoe 69. Reference can be made for example to document FR2611096 for further details on the manner in which the pole shoes 69 are secured on the head 66.

The pole shoes 69 are separated from an outer periphery of the rotor 9 by an air gap 76 which varies according to its circumference. It will be appreciated that the variation of the air gap 76 according to the invention is greater than the variations of the air gap 76 caused by the tolerance intervals which intervene in the embodiment of the stator 8 and the rotor 9. In fact, the variation of the air gap 76 is at least one millimetre. Preferably, the air gap 76 is larger between an area of the flare 73 and the rotor 9 than between a central portion 77 of the pole shoe 69 and the rotor 9, in which it is for example approximately 0.65 mm.

As can be seen clearly in FIG. 3, the increase in the air gap 76 is obtained by discontinuity of the inner faces 74 of the pole shoes 69 situated opposite the rotor 9. This discontinuity breaks the regularity of the arc of a circle which defines part of the inner face 74 of each pole shoe 69. In this case, the discontinuity is defined by two flat surfaces 80 which are provided in the flare 73 on the side of the longitudinal edges of the said flare 73. Thus, at least part of the flare 73 is not in the extension of the arc of a circle which defines part of the corresponding inner face 74.

A first plane P1 is defined parallel to the axis X of the stator 8 passing via an outer end of a flat surface 80, and a second plane P2 is defined parallel to the axis X passing via an intersection between a circle C1 corresponding to the arc of a circle which defines part of an inner face 74, and a third plane P3 is defined perpendicular to the first plane P1 passing via the said outer end of the flat surface 80. Preferably, each flat surface 80 is situated on the first plane P1. Alternatively, each flat surface 80 can be inclined relative to the plane P1, as represented in broken lines.

As a variant, the discontinuity of the inner faces 74 can be obtained by means of any other form, such as surfaces in the form of a “V” or a “U”, a sawtooth form, or crenellations. As a variant, the discontinuity can be provided at least partly in the central portion 77 of each pole shoe 69.

FIGS. 4a and 4b show graphic representations of the development of the amplitude A1 of the torque produced by the motor 5 and the amplitude A2 of the opposite of the rotary force according to the height of the chamfer, corresponding to the distance E between the first P1 and the second P2 planes. The relative force represents the amplitude of the rotary force which gives rise to the noise, compared with the force generated without variation of the air gap in the absence of a chamfer.

In this case, the rotary force which gives rise to the noise is the force which occurs at K=19 times the frequency of rotation of the rotor 9 which gives rise to the noise generated by the electric motor 5 in operation. The curves in FIGS. 4a and 4b have been obtained for a current IB supplied by the battery, corresponding to conventional cold starting of the thermal engine (IB=600 A) and to restarting of the thermal engine of the vehicle in stop and start mode (IB=250 A).

In order to obtain an optimum compromise between the reduction of the rotary force, so as to minimise the noise, and limited degradation of the engine torque which decreases with the height E of the chamfer, an optimum distance E of the air gap 76 of between 1.5 and 2.8 mm is selected.

According to another embodiment, the stator comprises a stack of plates which form the head 65 and the different magnetic poles.

According to another embodiment, the surface on which the air gap varies according to the circumference also varies axially. For example, the outer surface 80 varies radially. According to one embodiment, the outer surface 80 is on a plane which intersects the axis of the rotor. For example, the surface 80 which begins at an axial end of the magnetic pole as in FIG. 3 finishes at its other axial end closest to the rotor as represented by the broken lines identified as 80.

This therefore minimises the noise generated by the electric motor 5 of the starter 1, whilst maintaining efficient motor torque for both cases of operation of the starter 1 (conventional starting of the vehicle when its thermal engine is cold, and restarting of thermal engine which is already warm in stop and start mode).

According to an embodiment not represented, the air gap 76 between a circumferential surface of at least two magnetic poles opposite a circumferential surface of the said rotor and a circle with a radius of the exterior of the rotor 9 is varied by means of a groove. This groove can for example be situated in the shoulders on the surface opposite the rotor.

According to another embodiment represented in FIG. 5, the air gap 76 between a circumferential surface of at least two magnetic poles opposite a circumferential surface of the said rotor and a circle with a radius of the exterior of the rotor 9 varies in the central area 77. In this case, it is varied by means of a groove situated in the surface opposite the rotor.

It will be appreciated that the depth of this groove can be varied along its length.

In this embodiment, the width L of the part which forms the variation, in this case the groove, measured according to the circumference (an arc of a circle) of the inner face 74 represents at least 10% of its surface.

In the first embodiment represented in FIG. 3, the sum of the widths L of the flat surface 80 is close to 30% of the length of the surface opposite the rotor.

In these embodiments, it is preferable for the width or the sum of the widths of the parts which form the variation of the air gap to form more than 5% and less than 40%. In fact, as can be seen in FIGS. 4a and 4b, if this percentage is too low there is no effect, and if it is too high, the effects are toned down.

1. Starter (1) for a thermal engine of a motor vehicle comprising a rotary electrical machine (5) provided with a rotor (9) and a stator (8), comprising a plurality of magnetic poles (65) arranged on an inner circumference of a head (66), wherein each magnetic pole (65) projects relative to the head surrounded by a winding (70), wherein an air gap (76) between a circumferential surface of at least two magnetic poles opposite a circumferential surface of said rotor and a circle with a radius of the exterior of the rotor (9) varies by at least 1 mm.

2. Starter according to claim 1, wherein each magnetic pole is constituted by a pole shoe (69) fitted against the head of the stator.

3. Starter according to claim 1, wherein the stator comprises a stack of plates forming the head (65) and the different magnetic poles.

4. Starter according to claim 1, comprising a central portion around which the coil is wound and two flares (73) on both sides of the central area (77), in which the air gap between a circumferential surface of at least two magnetic poles opposite a circumferential surface of the said rotor and a circle with a radius of the exterior of the rotor (9) varies between 1 mm and the depth (P) contained measured between the outer radius of one of the flares and the inner radius of this same flare (73).

5. Starter according to claim 1, wherein the magnetic pole comprises a groove which forms the variation of the air gap.

6. Starter according to claim 5, wherein the groove is situated in the surface opposite the rotor and in the central portion situated between the two flares (73).

7. Starter according to claim 1, wherein the air gap varies by at least 1 mm on a circumferential end of its circumferential surface.

8. Starter according to claim 1, wherein, with each magnetic pole (69) comprising a flare (73), said air gap (76) is larger between an area of the said flare (73) and said rotor (9) than between a central portion (77) of the magnetic pole (69) and said rotor (9).

9. Starter according to claim 1, wherein an increase in said air gap (76) is obtained by means of a discontinuity of an inner face (74) of at least one magnetic pole (69) situated opposite said rotor.

10. Starter according to claim 9, wherein the discontinuity is defined by at least one flat surface (80) provided in the inner face (74) of a magnetic pole (69).

11. Starter according to claim 8 wherein said flat surface (80) is provided in said flare (73).

12. Starter according to claim 11, wherein there is definition of a first plane (P1) parallel to an axis (X) of said stator (8) passing via an outer end of said flat surface (80), a second plane (P2) parallel to said axis (X) of said stator (8) passing via an intersection between a circle (C1) corresponding to an arc of a circle defining part of an inner face (74) of a magnetic pole (69), and a third plane (P3) perpendicular to the first plane (P1) passing via said outer end of said flat surface (80), and in that the distance between the first (P1) and the second (P2) planes corresponding to a chamfer height provided in said flare (73) is between 1.5 mm and 2.8 mm.

13. Starter according to claim 11, wherein said flat surface (80) is situated substantially on the first plane (P1).

14. Starter according to claim 1, wherein said rotor (9) comprises 19 notches which are designed to receive conductors for the formation of a rotor winding (63).

15. Starter according to claim 1, wherein the surface on which the air gap varies according to the circumference also varies axially.

16. Pole shoe (69) belonging to an inductor of an electric starter motor (5) of a motor vehicle, wherein it comprises an inner face which is designed to be situated opposite a rotor (9) of said electric motor (5), with a discontinuity which breaks the regularity of an arc of a circle which defines part of said inner face (80).

17. Starter according to claim 2, comprising a central portion around which the coil is wound and two flares (73) on both sides of the central area (77), in which the air gap between a circumferential surface of at least two magnetic poles opposite a circumferential surface of said rotor and a circle with a radius of the exterior of the rotor (9) varies between 1 mm and the depth (P) contained measured between the outer radius of one of the flares and the inner radius of this same flare (73).

18. Starter according to claim 3, comprising a central portion around which the coil is wound and two flares (73) on both sides of the central area (77), in which the air gap between a circumferential surface of at least two magnetic poles opposite a circumferential surface of said rotor and a circle with a radius of the exterior of the rotor (9) varies between 1 mm and the depth (P) contained measured between the outer radius of one of the flares and the inner radius of this same flare (73).

19. Starter according to claim 2, wherein the magnetic pole comprises a groove which forms the variation of the air gap.

20. Starter according to claim 3, wherein the magnetic pole comprises a groove which forms the variation of the air gap.

21. Starter according to claim 4, wherein the magnetic pole comprises a groove which forms the variation of the air gap.
